(19) United States
(12) Patent Application Publication
(10) Pub. No.: US 2026/0225382 A1
(43) Pub. Date: Aug. 6, 2026

(54) MARK DETECTION METHOD, DISTORTION AMOUNT MEASUREMENT METHOD, LEARNING METHOD, ESTIMATION METHOD, AND PRINTING METHOD

(71) Applicant: SCREEN Holdings Co., Ltd., Kyoto (JP)

(72) Inventors: Yusuke KUBO, Kyoto-shi, Kyoto (JP); Mitsuru YAMBE, Kyoto-shi, Kyoto (JP)

(21) Appl. No.: 19/150,307

(22) PCT Filed: Dec. 8, 2023
(86) PCT No.: PCT/JP2023/043972

§ 371 Date: Jul. 23, 2025

(30) Foreign Application Priority Data
Feb. 3, 2023 (JP) 2023-015279

(51) Int. Cl. B41J 11/46; B41J 2/21; B41J 11/00

(52) U.S. Cl. CPC B41J 11/46; B41J 2/2135; B41J 11/008

(57) ABSTRACT

This mark detection method includes a first mark detection step, a detection abnormality determination step, and a second mark detection step to detect a position of a position detection mark on a base material on which a learning image is printed in which a position detection mark is arranged at each of a plurality of mark arrangement positions. In the first mark detection step, a region that meets a first condition is detected as a region to be detected in a photographic image of the base material on which the learning image is printed. In the detection abnormality determination step, the mark arrangement position is compared with the region to be detected to determine a detection abnormality. In the second mark detection step, a region that meets a second condition is detected as a new region to be detected around the mark arrangement position determined as the detection abnormality.

### TECHNICAL FIELD

The present invention relates to a technique for estimating an amount of distortion due to expansion and contraction of an elongated strip-shaped base material in a printing apparatus that ejects ink onto a surface of the base material while transporting the base material in a longitudinal direction thereof.

### BACKGROUND ART

An inkjet printing apparatus for printing an image on an elongated strip-shaped base material by ejecting ink from a plurality of heads while transporting the base material in a longitudinal direction thereof has heretofore been known. The inkjet printing apparatus ejects inks of different colors from the respective heads. Then, the inkjet printing apparatus prints a multi-color image on a surface of the base material by superimposing single-color images formed by the respective inks of the different colors.

In the printing apparatus of this type, the base material expands or contracts slightly when the base material absorbs the inks or when the inks on the base material become dry. As a result, a printed image formed on the surface of the base material 9 is distorted. Also, there are cases in which the position of the inks ejected from the heads is improper due to the expansion and contraction of the base material.

An amount of expansion/contraction of the base material varies depending on various conditions such as the tension applied to the base material, the type of base material, and the type of ink. In addition, there are cases in which the amount of expansion/contraction of the base material varies between printing apparatuses of the same type due to differences between machines. Further, an expansion/contraction state of the base material, which varies depending on image data to be printed, cannot be known prior to printing in conventional techniques.

Therefore, in order to suppress deterioration of print quality due to expansion/contraction of the base material as much as possible, a printing apparatus described in Patent Literature 1 generates an estimation model by machine learning using a learning image to which a position detection mark for identifying coordinates in a printed image is attached, and the printing apparatus estimates an expansion/contraction state of the base material according to submitted data by using the estimation model prior to printing. Thus, an ejection position of ink can be corrected in accordance with distortion due to expansion and contraction of the base material, and a deviation of the printed image between heads can be suppressed.

### CITATION LIST

### Patent Literature

Patent Literature 1: JP 2022-110632 A

### SUMMARY OF INVENTION

### Technical Problem

In generating such an estimation model, in order to obtain the estimation model with higher accuracy, it is necessary to more accurately detect the position detection mark for identifying coordinates in the printed image of the learning image.

The present invention has been made in view of such circumstances, and an object thereof is to provide a technique capable of more accurately detecting a position of a position detection mark on a base material on which a learning image is printed.

### Solution to Problem

In order to solve the aforementioned problem, a first aspect of the present invention is intended for a mark detection method for detecting a position of a position detection mark on a base material on which a learning image is printed in which the position detection mark is arranged at each of a plurality of mark arrangement positions, the mark detection method including: a first mark detection step of detecting, as a region to be detected, a region that meets a first condition that is predetermined, in a photographic image of the base material on which the learning image is printed; a detection abnormality determination step of determining a detection abnormality by comparing each of the mark arrangement positions with the region to be detected; and a second mark detection step of detecting, as the region to be detected that is new, a region that meets a second condition that is predetermined, around each of the mark arrangement positions determined as the detection abnormality.

A second aspect of the present invention is intended for the mark detection method of the first aspect, in which, in the detection abnormality determination step, the detection abnormality includes at least a case where the region to be detected corresponding to a mark arrangement position among the mark arrangement positions is not detected; and a case where a distance between a mark arrangement position among the mark arrangement positions and the region to be detected corresponding to the mark arrangement position is a predetermined outlier threshold value or more.

A third aspect of the present invention is intended for the mark detection method of the first aspect or the second aspect, in which the first condition is a region closest to each of the mark arrangement positions among first candidate regions whose degree of matching with the position detection mark is larger than a first matching degree threshold value that is predetermined, the second condition is a region closest to each of the mark arrangement positions determined as the detection abnormality among second candidate regions whose degree of matching with the position detection mark is larger than a second matching degree threshold value that is predetermined, and the second matching degree threshold value has a degree of matching lower than a degree of matching of the first matching degree threshold value.

A fourth aspect of the present invention is intended for the mark detection method of any one of the first to third aspects of the present invention, in which the position detection mark includes: a base figure formed in a first color; and a mark figure formed in a second color different from the first color at a position overlaid on the base figure.

A fifth aspect of the present invention is intended for the mark detection method of the fourth aspect, in which the first color is white, and the second color is black.

A sixth aspect of the present invention is intended for a distortion amount measurement method for measuring an amount of distortion of an image printed on a base material, the distortion amount measurement method including: a printing step of printing, on the base material, a learning image in which a position detection mark is arranged at each of a plurality of mark arrangement positions; a photographic image acquisition step of photographing the base material on which the learning image is printed, to acquire a photographic image; a mark detection step of detecting the region to be detected in the photographic image by the mark detection method of any one of the first to fifth aspects of the present invention; and a distortion amount calculation step of calculating an amount of distortion of the base material for each of the mark arrangement positions by comparing each of the mark arrangement positions with the region to be detected.

A seventh aspect of the present invention is intended for a distortion amount measurement method of the sixth aspect, in which the amount of distortion indicates an amount of displacement of each of a plurality of the position detection marks from each of the mark arrangement positions to the region to be detected.

An eighth aspect of the present invention is intended for a distortion amount measurement method of the sixth aspect, in which the amount of distortion indicates a change in an interval between adjacent mark arrangement positions among the mark arrangement positions and an interval between the regions to be detected that are corresponding to the adjacent mark arrangement positions.

A ninth aspect of the present invention is intended for a learning method for machine learning an estimation model for estimating an amount of distortion of an elongated strip-shaped base material, in a printing apparatus that ejects ink onto a surface of the base material while transporting the base material in a longitudinal direction, the learning method including: a distortion amount measurement step of measuring an amount of distortion of the base material by the distortion amount measurement method of any one of the sixth to eighth aspects, in a learning image in which a position detection mark is arranged at each of a plurality of mark arrangement positions; and a learning step of generating an estimation model capable of outputting an estimation result obtained by estimating an amount of distortion of the base material, by machine learning using the learning image as an input variable and using the amount of distortion measured in the distortion amount measurement step as teacher data.

A tenth aspect of the present invention is intended for the learning method of the ninth aspect, in which the learning image is image data including a plurality of regions having different density values or different coverage rates.

An eleventh aspect of the present invention is intended for an estimation method for estimating an amount of distortion of an elongated strip-shaped base material, in a printing apparatus that ejects ink onto a surface of the base material while transporting the base material in a longitudinal direction, the estimation method including: a data acquisition step of acquiring submitted data that is image data to be printed; and an estimation step of inputting the submitted data to the estimation model learned by the learning method of the ninth aspect or the tenth aspect, and acquiring the estimation result output from the estimation model, prior to printing the submitted data.

A twelfth aspect of the present invention is intended for a printing method using the estimation method of the eleventh aspect, in which the printing method further includes a printing step for ejecting ink onto a surface of the base material while correcting an ejection position of ink onto the base material, based on the estimation result, the printing step being performed after the data acquisition step and the estimation step.

### Advantageous Effects of Invention

According to the first to twelfth aspects of the present invention, after the position detection mark is detected for the first time, detection of the position detection mark is performed again for a detection abnormality. As a result, a position of the position detection mark can be more accurately detected on the base material on which the learning image is printed.

In particular, according to the third aspect of the present invention, after a region with a high degree of matching is detected for the first time, detection is performed again with a lowered threshold value of the degree of matching, for the position detection mark of the detection abnormality. As a result, it is possible to detect a position detection mark having a lowered degree of matching due to circumstances such as a case where there is a stain around the mark.

### BRIEF DESCRIPTION OF DRAWINGS

FIG. 1 is a diagram showing a configuration of a printing apparatus.

FIG. 2 is a partial top view of the printing apparatus in the vicinity of a printing part.

FIG. 3 is a block diagram showing connections between components of the printing apparatus and a computer.

FIG. 4 is a block diagram conceptually showing functions of the computer.

FIG. 5 is a flow diagram showing a procedure for a learning process.

FIG. 6 is a view showing an example of learning data.

FIG. 7 is an enlarged view of one part of the learning data.

FIG. 8 is an enlarged view of a part of an example of a photographic image.

FIG. 9 is a view showing an example of learning data.

FIG. 10 is a flow diagram showing a flow of a distortion amount measurement step.

FIG. 11 is a view showing an example of a mark arrangement position and a first candidate region.

FIG. 12 is a view showing an example of a mark arrangement position and a second candidate region.

FIG. 13 is a view showing an example of a method of measuring an expansion/contraction state of a base material.

FIG. 14 is a view showing another example of the method of measuring an expansion/contraction state of the base material.

FIG. 15 is a flow diagram showing a procedure for a printing process.

### DESCRIPTION OF EMBODIMENT

A preferred embodiment according to the present invention will now be described with reference to the drawings.

### <1. Configuration of Printing Apparatus>

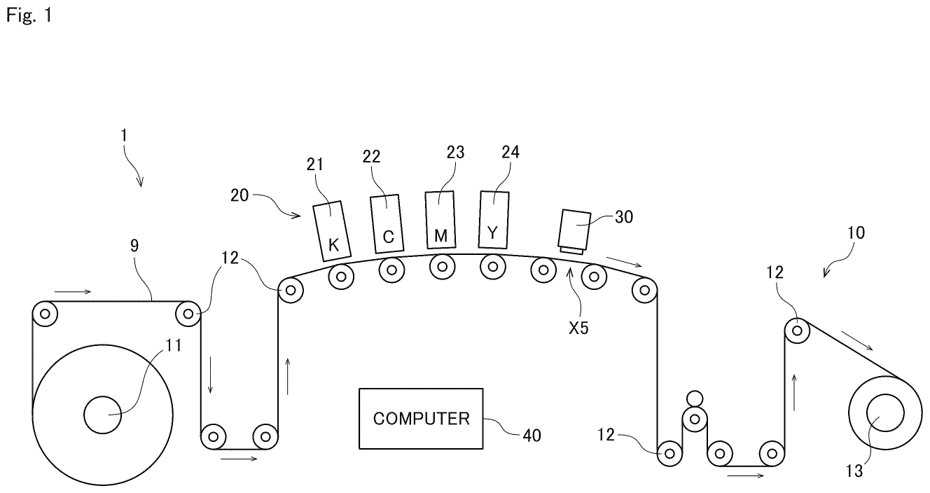

FIG. 1 is a diagram showing a configuration of a printing apparatus 1 according to a preferred embodiment of the present invention. The printing apparatus 1 is an apparatus for printing an image on a surface of an elongated strip-shaped base material 9 (print medium) by ejecting droplets of ink from a plurality of heads 21 to 24 toward the base material 9 while transporting the base material 9. The base material 9 may be printing paper or a resin film. The base material 9 may also be metal foil or a glass base material. As shown in FIG. 1, the printing apparatus 1 includes a transport mechanism 10, a printing part 20, a camera 30, and a computer 40.

The transport mechanism 10 transports the base material 9 in a transport direction extending along a longitudinal direction of the base material 9. The transport mechanism 10 of the present preferred embodiment includes an unwinder 11, a plurality of transport rollers 12, and a winder 13. The base material 9 is unwound from the unwinder 11, and is transported along a transport path formed by the transport rollers 12. Each of the transport rollers 12 rotates about an axis extending in a direction perpendicular to the transport direction to guide the base material 9 downstream along the transport path. The transported base material 9 is wound and collected on the winder 13. The base material 9 is tensioned in the transport direction. This suppresses slack and wrinkles in the base material 9 during the transport.

The printing part 20 is a processing part that ejects droplets of ink onto the base material 9 transported by the transport mechanism 10. Hereinafter, the droplets of ink are referred to as “ink droplets”. The printing part 20 of the present preferred embodiment includes a first head 21, a second head 22, a third head 23, and a fourth head 24. The first head 21, the second head 22, the third head 23, and the fourth head 24 are arranged in spaced apart relation in the transport direction of the base material 9. The base material 9 is transported under the four heads 21 to 24, with a printing surface thereof facing upward.

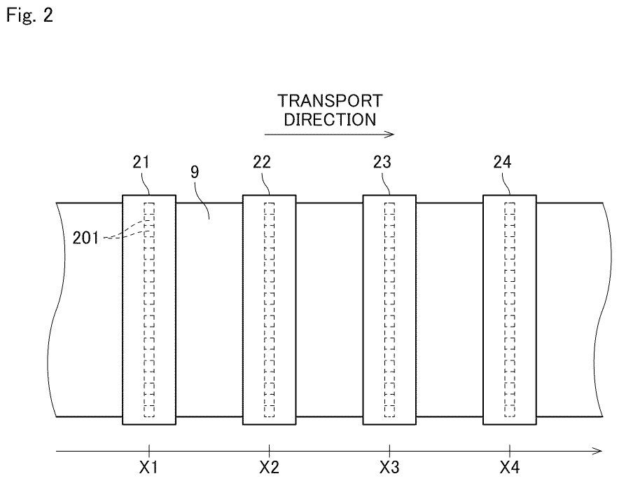

FIG. 2 is a partial top view of the printing apparatus 1 in the vicinity of the printing part 20. As indicated by broken lines in FIG. 2, each of the heads 21 to 24 has a lower surface provided with a plurality of nozzles 201 arranged parallel to the width direction of the base material 9. Each of the heads 21 to 24 ejects ink droplets of four colors, i.e., K (black), C (cyan), M (magenta), and Y (yellow), respectively, which serve as color components of a multi-color image from the nozzles 201 toward an upper surface of the base material 9.

The first head 21 ejects K-color ink droplets toward the upper surface of the base material 9 in a first printing position X1 lying on the transport path. The second head 22 ejects ink droplets of C-color toward the upper surface of the base material 9 in a second printing position X2 downstream of the first printing position X1. The third head 23 ejects ink droplets of M-color toward the upper surface of the base material 9 in a third printing position X3 downstream of the second printing position X2. The fourth head 24 ejects ink droplets of Y-color toward the upper surface of the base material 9 in a fourth printing position X4 downstream of the third printing position X3.

A fixing part for fixing the inks on the printing surface of the base material 9 may be further provided downstream of the heads 21 to 24 as seen in the transport direction. The fixing part, for example, blows a heated gas toward the base material 9 to dry the inks adhering to the base material 9. The fixing part may be of the type which irradiates UV-curable inks with UV light to cure the inks.

The camera 30 is an imaging device for photographing the printing surface of the base material 9 having passed the printing part 20. The camera 30 is disposed in opposed relation to the printing surface of the base material 9 in a photographing position X5 downstream from the four heads 21 to 24 along the transport path. For example, a line sensor including a plurality of imaging elements, such as CCD, CMOS, and other imaging elements, arranged in the width direction is used as the camera 30. The camera 30 photographs the printing surface of the base material 9 to thereby acquire a photographic image. Then, the camera 30 sends the acquired photographic image to the computer 40.

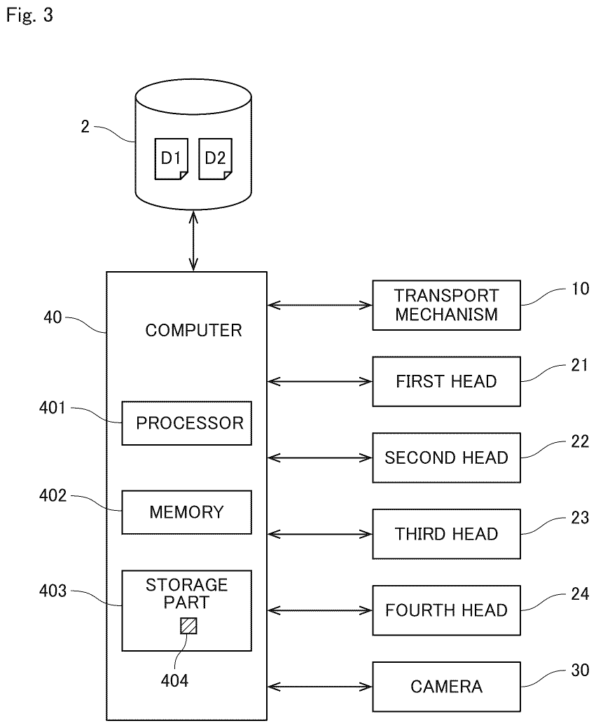

The computer 40 is an information processing device for controlling the printing apparatus 1. FIG. 3 is a block diagram showing connections between the computer 40 and the components of the printing apparatus 1. As conceptually shown in FIG. 3, the computer 40 includes a processor 401 such as a CPU, a memory 402 such as a RAM, and a storage part 403 such as a hard disk drive. A computer program 404 for execution of a learning process and a printing process to be described later is stored in the storage part 403.

As shown in FIG. 3, the computer 40 is connected to the transport mechanism 10, the four heads 21 to 24, and the camera 30 for communication therewith. The computer 40 is also connected to a server 2 that is an external storage device for communication therewith. Submitted data D1 is stored in the server 2. The submitted data D1 is image data to be printed in the printing apparatus 1 for obtainment of a printed product. The computer 40 acquires the submitted data D1 from the server 2, and controls the operations of the transport mechanism 10 and the four heads 21 to 24, based on the submitted data D1. Thus, the printing process in the printing apparatus 1 proceeds. A large number of learning data D2 for use in the learning process to be described later are also stored in the server 2.

### <2. Functions of Computer>

In this printing apparatus 1, each of the four heads 21 to 24 ejects ink droplets to thereby print a single-color image on the upper surface of the base material 9. A multi-color image is formed on the upper surface of the base material 9 by superimposing the four single-color images. If the ink droplets ejected from the four heads 21 to 24 are out of position relative to each other on the base material 9, the image quality of a printed product is lowered. Controlling such misalignment, that is, misregistration between the single-color images on the base material 9 within an allowable range is an important factor for obtainment of high-quality printed products.

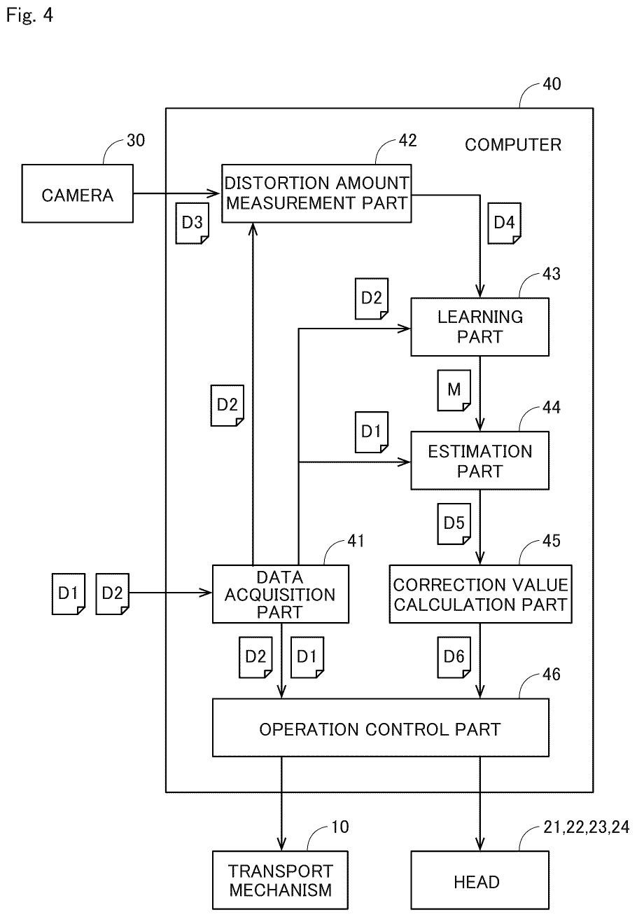

The base material 9 expands and contracts non-uniformly when the inks are absorbed by the base material 9 or when the inks on the base material 9 become dry. The occurrence of such expansion and contraction of the base material 9 distorts a printed image formed on the printing surface. The occurrence of such expansion and contraction of the base material 9 also makes the aforementioned misregistration prone to occur. To overcome these disadvantages, the computer 40 of the printing apparatus 1 has the function of estimating the expansion/contraction state of the base material 9 prior to printing based on the submitted data D1 to perform printing while correcting the ejection positions of the ink droplets through the use of the estimation result. FIG. 4 is a block diagram conceptually showing functions of the computer 40.

As shown in FIG. 4, the computer 40 includes a data acquisition part 41, a distortion amount measurement part 42, a learning part 43, an estimation part 44, a correction value calculation part 45, and an operation control part 46. Functions of the data acquisition part 41, the distortion amount measurement part 42, the learning part 43, the estimation part 44, the correction value calculation part 45, and the operation control part 46 are implemented by the processor 401 of the computer 40 operating in accordance with the computer program 404.

The data acquisition part 41 acquires the submitted data D1 and the learning data D2. The data acquisition part 41 reads the submitted data D1 and the learning data D2 from the server 2. In addition, the data acquisition part 41 inputs the read learning data D2 to the distortion amount measurement part 42, the learning part 43, and the operation control part 46. The data acquisition part 41 also inputs the read submitted data D1 to the estimation part 44 and the operation control part 46.

The distortion amount measurement part 42 measures an amount of distortion of the base material 9 based on the learning data D2 and a photographic image D3 transmitted from the camera 30. A method of measuring the amount of distortion of the base material 9 will be described later. The distortion amount measurement part 42 inputs a measured amount of distortion D4 of the base material 9 to the learning part 43.

The learning part 43 learns a relationship between image data and an expansion/contraction state of the base material 9 which will result when the image data is printed. This printing apparatus 1 performs the learning process by means of the learning part 43 prior to the printing of the submitted data DI for obtainment of a printed product. During the learning process, the learning data D2 that is a learning image is inputted to the aforementioned operation control part 46 and the learning part 43. The operation control part 46 controls the operations of the transport mechanism 10 and the printing part 20, based on the learning data D2. Thus, the learning data D2 is printed on the printing surface of the base material 9. During the learning process, the camera 30 photographs the base material 9 subjected to the printing.

The learning part 43 uses the learning data D2 as an input variable and uses the amount of distortion D4 measured by the distortion amount measurement part 42 as teacher data, to perform the learning process by means of a supervised machine learning algorithm. The learning part 43 repeats such a learning process until a predetermined termination condition is satisfied. As a result, the learning part 43 generates an estimation model M that can output an estimation result indicating the expansion/contraction state of the base material 9 based on the input image data. The details on the learning process will be described later.

The learning part 43 uses, for example, deep learning (a multi-layer neural network) as the machine learning algorithm. However, the machine learning algorithm used by the learning part 43 is not limited to the deep learning. Instead of deep learning, other machine learning algorithms such as Markov random field (MRF) or Boltzmann machine may be used.

The estimation part 44 estimates an amount of distortion of the base material 9 which will result when the submitted data D1 is printed based on the submitted data D1. The estimation part 44 uses the estimation model M generated by the learning part 43 to perform an estimation process. The estimation part 44 inputs the submitted data D1 acquired by the data acquisition part 41 to the estimation model M. Then, the amount of distortion of the base material 9 corresponding to the submitted data D1 is outputted from the estimation model M. The estimation part 44 uses the amount of distortion outputted from the estimation model M as an estimation result D5.

The correction value calculation part 45 calculates a correction value D6, based on the estimation result D5. The correction value calculation part 45 calculates the correction value D6 in a direction for canceling the amount of distortion of the base material 9 indicated by the estimation result D5. The calculated correction value D6 is inputted to the operation control part 46.

The operation control part 46 controls operations of the transport mechanism 10 and the four heads 21 to 24. When printing the aforementioned learning data D2, the operation control part 46 outputs a command value based on the learning data D2 to the transport mechanism 10 and the four heads 21 to 24. Thus, the operation control part 46 brings the transport mechanism 10 and the four heads 21 to 24 into operation to print the learning data D2 on the printing surface of the base material 9. When printing the submitted data D1, on the other hand, the operation control part 46 corrects a command value based on the submitted data D1 with the use of the correction value D6. Then, the operation control part 46 outputs the corrected command value to the transport mechanism 10 and the four heads 21 to 24. Thus, the operation control part 46 brings the transport mechanism 10 and the four heads 21 to 24 into operation to print the submitted data D1 on the printing surface of the base material 9.

### <3. Learning Process>

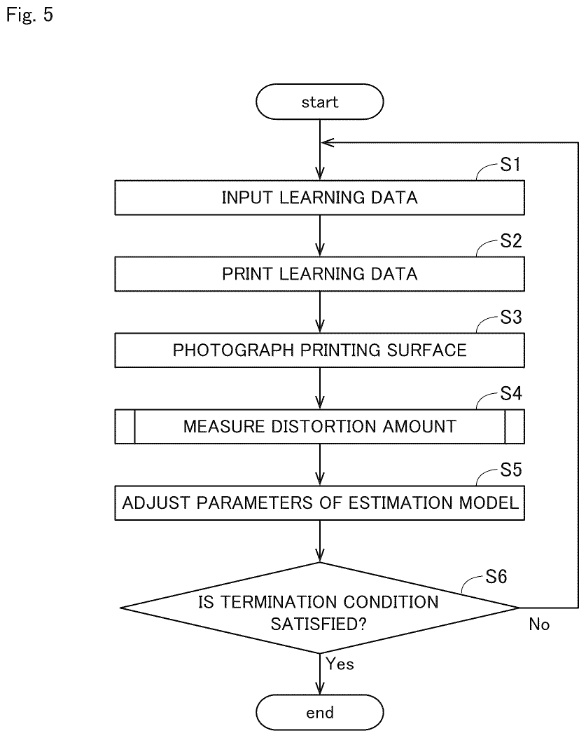

Next, the learning process for execution in the aforementioned printing apparatus 1 will be described. FIG. 5 is a flow diagram showing a procedure for the learning process. This learning process is performed prior to the printing of the submitted data D1 for obtainment of a printed product.

For the learning process, the data acquisition part 41 initially reads the learning data D2 from the server 2, as shown in FIG. 5. Then, the data acquisition part 41 inputs the learning data D2 to the learning part 43 and the operation control part 46 (Step S1; an input step).

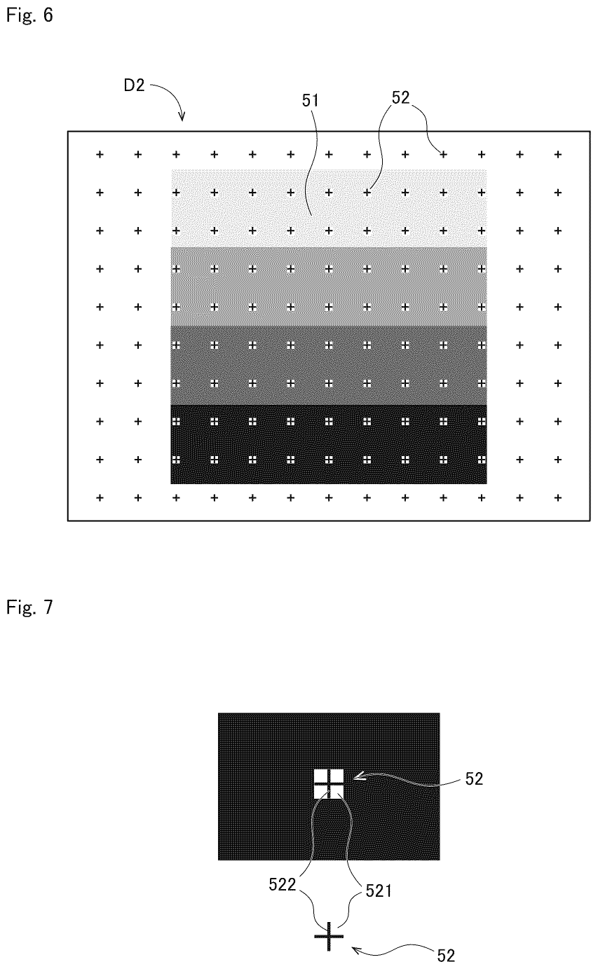

FIG. 6 is a view showing an example of the learning data D2. As shown in FIG. 6, the learning data D2 is image data in which a plurality of grid marks 52 are incorporated in an image 51 such as a picture or a pattern. The multiple learning data D2 have respective images 51 different from each other. The amount of distortion of the base material 9 varies depending on amounts of inks ejected onto the base material 9. It is hence desirable that the image 51 of the learning data D2 is an image including a plurality of regions different in density value or coverage rate. This allows the learning of the amount of distortion of the base material 9 in accordance with the density value or the coverage rate.

The grid mark 52 is a position detection mark indicating a predetermined coordinate position in the learning data D2. The grid marks 52 are arranged at plurality of mark arrangement positions of the learning data D2. In the present preferred embodiment, the grid marks 52 are arranged over the entire learning data D2. The grid marks 52 are also arranged in spaced apart relation in the transport direction and the width direction of the base material 9. In the learning data D2, the grid marks 52 are disposed on the front side of the image 51.

FIG. 7 is an enlarged view of one part of the learning data D2. As shown in FIG. 7, such a grid mark 52 of the present preferred embodiment is comprised of a base FIG. 521 and a mark FIG. 522. The base FIG. 521 is a white rectangular figure. The mark FIG. 522 is a black cross-shaped figure overlaid on the front side of the base FIG. 521. Note that the white color has a density value of 0%, and the black color has a density value of 100%. In a case where the grid mark 52 is arranged on a black background as in the upper region of FIG. 7, the background and the mark FIG. 522 are black that is the same as each other, but the mark FIG. 522 can be identified since the mark FIG. 522 is on the white base FIG. 521. In addition, in a case where the grid mark 52 is arranged on a white background as in the lower region of FIG. 7, a boundary cannot be identified since the base FIG. 521 and the background are white that is the same as each other, but the black mark FIG. 522 can be identified.

In the present preferred embodiment, the grid mark 52 is comprised of the white base FIG. 521 and the black mark FIG. 522 that is overlaid on the front side of the base FIG. 521 in this manner. This makes the mark FIG. 522 recognizable regardless of the color of the image 51 serving as the background.

The operation control part 46 controls the operations of the transport mechanism 10 and the four heads 21 to 24, based on the learning data D2. Thus, the learning data D2 is printed on the printing surface of the base material 9 (Step S2; a printing step). Specifically, the plurality of grid marks 52 together with the image 51 are printed on the printing surface of the base material 9. Further, the camera 30 photographs the printing surface of the base material 9 on which the learning data D2 is printed (Step S3; a photographic image acquisition step). The photographic image D3 obtained by the photographing is sent from the camera 30 to the computer 40 and inputted to the distortion amount measurement part 42.

The distortion amount measurement part 42 measures an amount of distortion of the base material 9 based on the photographic image D3 transmitted from the camera 30 (Step S4; a distortion amount measurement step). The distortion amount measurement step (S4) will be described in detail later. The distortion amount measurement part 42 inputs the obtained amount of distortion D4 of the base material 9 to the learning part 43.

The learning part 43 uses the learning data D2 inputted from the data acquisition part 41 in Step S1 as an input variable and uses the amount of distortion D4 of the base material 9 measured in Step S4 as teacher data, to perform machine learning using a supervised machine learning program. In this process, the learning part 43 prepares the estimation model M for estimating the amount of distortion of the base material 9, based on the image data. The estimation model M outputs an estimation result of the amount of distortion, based on the inputted learning data D2. The learning part 43 adjusts parameters of the estimation model M so that the estimation result outputted from the estimation model M is closer to the amount of distortion D4 that is the teacher data (Step S5; a learning step).

Thereafter, the learning part 43 judges whether a predetermined termination condition is satisfied or not (Step S6). The termination condition may be, for example, that a difference between the estimation result and the teacher data is less than a preset threshold value. Alternatively, the termination condition may be that the number of repetitions of Steps S1 to S5 reaches a preset threshold value. If the termination condition is not satisfied (No in Step S6), the computer 40 repeats the process of Steps S1 to S5 described above. At this time, the learning data D2 may be that from a different image 51.

The estimation accuracy of the estimation model M is improved by repeating the learning process of Steps S1 to S5. Then, when the termination condition is satisfied (Yes in Step S6), the learning part 43 terminates the learning process. As a result, based on the input image data, the learned estimation model M is generated that can accurately estimate the amount of distortion of the base material 9 which will result when the image data is printed. The learning part 43 provides the generated estimation model M to the estimation part 44.

A predetermined number of learning data D2 may be used as a single learning data set. Then, the learning process may be performed on a plurality of learning data sets. In this case, while a predetermined number of learning data D2 included in the single learning data set are printed, the process of Steps S1 to S5 may be repeated without judging the termination condition in Step S6. Then, when the process of Steps S1 to S5 is completed for all of the learning data D2 included in the single learning data set, the judgment of the termination condition in Step S6 may be made. If the termination condition is not satisfied in Step S6, the learning process of Steps S1 to S5 may be performed on another learning data set.

### <4. Distortion Amount Measurement Step>

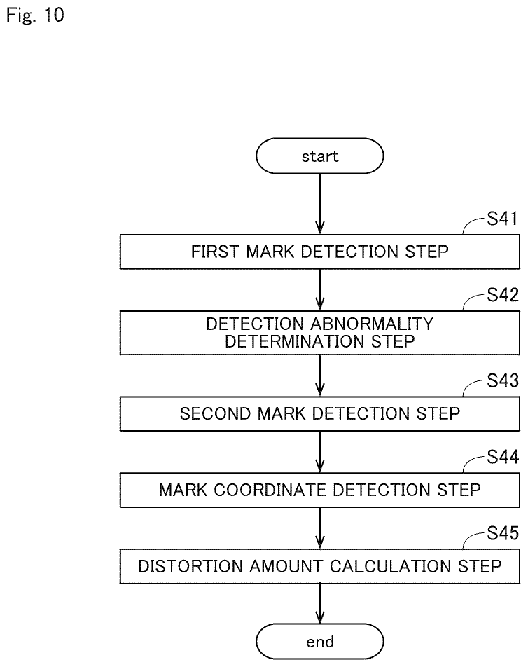

Here, a flow of the distortion amount measurement step in Step S4 will be described. In the distortion amount measurement step (S4), the grid mark 52 is identified from the photographic image D3, and the amount of distortion D4 of the base material 9 is measured. FIG. 10 is a flow diagram showing a flow of the distortion amount measurement step (S4).

At this time, in a print result of the learning data D2 photographed in the photographic image D3, in a case where a stain adheres to the grid mark 52 or a portion similar to the grid mark 52 exists in the image included in the learning data D2, there is a possibility that the grid mark 52 in the photographic image D3 cannot be accurately recognized.

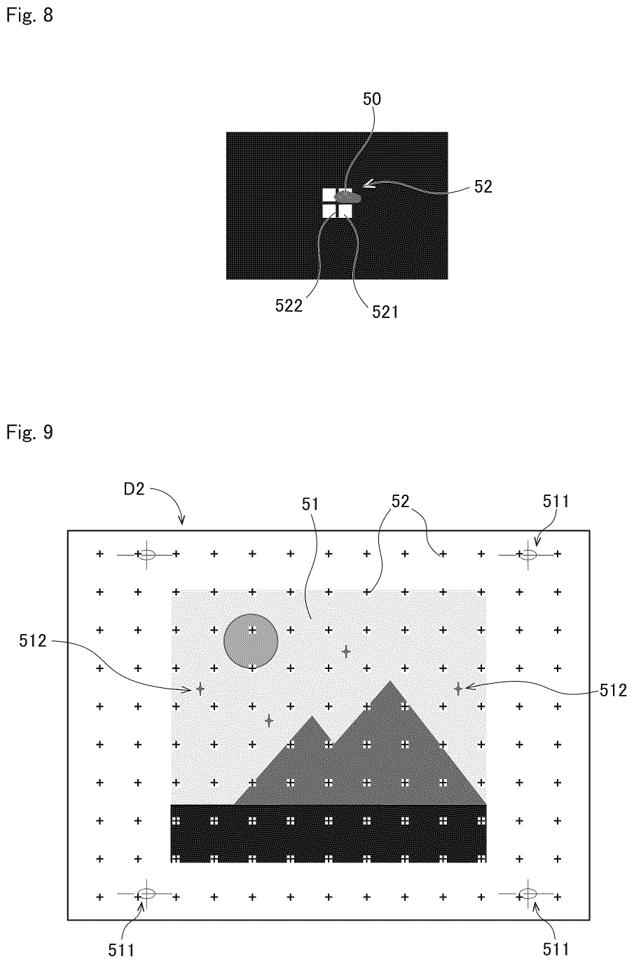

FIG. 8 is an enlarged view in which a part of an example of the photographic image D3 in a case where a stain 50 adheres onto the grid mark 52 is enlarged. In a method of calculating a degree of matching between a template image of the grid mark 52 and the photographic image D3 and extracting the grid mark 52 in the photographic image D3, when stain 50 caused by ink or the like adheres onto the grid mark 52 as in the example of FIG. 8, the degree of matching becomes low and the detection becomes difficult, which causes non-detection.

FIG. 9 is an example of the learning data D2 having a portion similar to the grid mark 52. In the learning data D2 of the example of FIG. 9, the image 51 has a portion similar to the grid mark 52, such as a register mark 511 and a picture 512 representing a star. Therefore, the register mark 511 and the picture 512 may be erroneously detected as the grid mark 52.

In order to suppress such non-detection and erroneous detection, as shown in FIG. 10, the distortion amount measurement part 42 detects the grid mark 52 from the photographic image D3 in two stages of the first mark detection step (S41) and the second mark detection step (S43), and measures the amount of distortion D4 of the base material 9. FIG. 10 is a flow diagram showing a flow of the distortion amount measurement step in Step S4.

As shown in FIG. 10, in the distortion amount measurement step (S4), the distortion amount measurement part 42 first detects, as a region to be detected, a region that meets a predetermined first condition from the photographic image D3 (Step S41; a first mark detection step). Here, the first condition is that a distance to the mark arrangement position is the shortest among first candidate regions whose degree of matching with the grid mark 52 is larger than a predetermined first matching degree threshold value. Note that the mark arrangement position is a position where the grid mark 52 is arranged in the learning data D2, that is, an ideal position of the grid mark 52 in a case where no distortion occurs in the printing position of the base material 9.

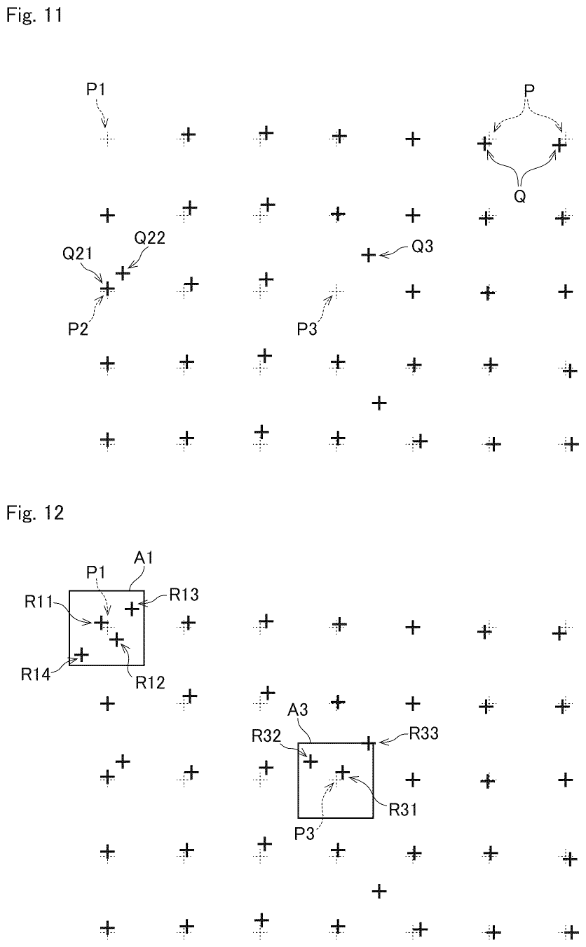

In the first mark detection step (S41), first, the degree of matching with the grid mark 52 is calculated for the entire region of the photographic image D3. Then, a first candidate region Q is extracted in which the degree of matching with the grid mark 52 is larger than a predetermined first matching degree threshold value. FIG. 11 is a view showing an example of the mark FIG. 522 in the first candidate region Q and the mark FIG. 522 at a mark arrangement position P where the grid mark 52 is arranged in the learning data D2. In FIG. 9, an example of the mark arrangement position P is indicated by a dashed cross mark, and an example of the first candidate region Q is indicated by a solid cross mark.

In the first mark detection step (S41), a region closest to each mark arrangement position P is selected from such first candidate regions Q, as the region to be detected of the mark arrangement position P.

In the example of FIG. 11, the first candidate region Q does not exist in the vicinity of a mark arrangement position P1 among a plurality of the mark arrangement positions P. Therefore, the region to be detected corresponding to the mark arrangement position P1 is not detected. In addition, there are two first candidate regions Q21 and Q22 around a mark arrangement position P2. At this time, among the two first candidate regions Q21 and Q22, the first candidate region Q21 having a short distance from the mark arrangement position P2 is selected as the region to be detected corresponding to the mark arrangement position P2. Further, the region to be detected with respect to a mark arrangement position P3 is a first candidate region Q3 having the shortest distance. However, a distance between the mark arrangement position P3 and the first candidate region Q3 is clearly longer than a distance between the other mark arrangement positions P and corresponding regions to be detected.

Next, the distortion amount measurement part 42 compares the first candidate region detected in the first mark detection step (S41) with the mark arrangement position P, to determine detection abnormality (Step S42; a detection abnormality determination step). In the detection abnormality determination step (S42), the detection abnormality includes at least a case of non-detection and an outlier.

The non-detection is a case where the region to be detected (first candidate region) corresponding to the mark arrangement position is not detected. In addition, the outlier is a case where a distance between the mark arrangement position and the corresponding region to be detected (first candidate region) is a predetermined outlier threshold value or more. Note that the outlier threshold value may be a fixed value determined empirically in advance. Further, the outlier threshold value may be a numerical value statistically obtained from distances between the mark arrangement position and the first candidate region in the entire photographic image D3. In this case, the outlier threshold value may be, for example, a constant multiple of an average value of distances between the mark arrangement position and the first candidate region in the entire photographic image D3.

In the example of FIG. 11, since the first candidate region Q does not exist in the vicinity of the mark arrangement position P1, the mark arrangement position P1 corresponds to the non-detection. In addition, since the distance between the mark arrangement position P3 and the first candidate region Q3, which is the region to be detected with respect to the mark arrangement position P3, is the predetermined outlier threshold value or more, the mark arrangement position P3 corresponds to the outlier.

Subsequently, around the mark arrangement position P determined as the detection abnormality in the detection abnormality determination step (S42) in the photographic image D3, the distortion amount measurement part 42 detects a region that meets a predetermined second condition as a new region to be detected (Step S43; a second mark detection step).

Here, the second condition is that a distance to the mark arrangement position is the shortest among second candidate regions whose degree of matching with the grid mark 52 is larger than a predetermined second matching degree threshold value. Here, the second matching degree threshold value is lower in degree of matching than the first matching degree threshold value used in the first mark detection step (S41). Therefore, in the first mark detection step (S41), a region that has not been extracted as the first candidate region is extracted as the second candidate region.

In the second mark detection step (S42), a degree of matching with the grid mark 52 is calculated for a peripheral region of the mark arrangement position P determined as the detection abnormality. Then, a second candidate region R is extracted in which the degree of matching with the grid mark 52 is larger than the predetermined second matching degree threshold value. FIG. 12 is a view showing an example of the mark FIG. 522 at the mark arrangement position P in the example of FIG. 11 and the mark FIG. 522 in the second candidate region R. Then, a region closest to each mark arrangement position P is selected from such second candidate regions R, as the region to be detected of the mark arrangement position P.

In the example of FIG. 12, four second candidate regions R11, R12, R13, and R14 are extracted in a peripheral region Al of the mark arrangement position P1 where the first candidate region Q is not detected. Then, among the four second candidate regions R11, R12, R13, and R14, the second candidate region R11 closest to the mark arrangement position P1 is selected as the region to be detected.

In addition, three second candidate regions R31, R32, and R33 are extracted in a peripheral region A3 of the mark arrangement position P3 determined as the outlier. Among them, the second candidate region R33 is the same as the first candidate region Q3 extracted in the first mark detection step (S41). Then, among the three second candidate regions R31, R32, and R33, the second candidate region R31 closest to the mark arrangement position P3 is selected as a new region to be detected.

As described above, after candidate regions having a high degree of matching are detected in the first mark detection step (S41), the threshold value of the degree of matching is lowered in the second mark detection step (S42) for the mark arrangement position of the detection abnormality, and detection of candidate regions is performed again. As a result, it is possible to detect the grid mark 52 with a lowered threshold value of the degree of matching due to circumstances such as a case where there is stain around the mark.

When the region to be detected is determined for each mark arrangement position in the second mark detection step (S43), the distortion amount measurement part 42 detects mark coordinates of the region to be detected (Step S44; a mark coordinate detection step). Specifically, for the region to be detected, luminance values are summed in the transport direction with respect to individual coordinates in the width direction, the Gaussian function is fitted to the total luminance value, and center coordinates in the width direction are calculated from a vertex of the approximation function. Whereas, for the region to be detected, luminance values are summed in the width direction with respect to individual coordinates in the transport direction, the Gaussian function is fitted to the total luminance value, and center coordinates in the transport direction are calculated from a vertex of the approximation function. As a result, the center coordinates of the grid mark 52 in the region to be detected can be detected.

Thereafter, the center coordinates of the region to be detected that has been detected in the mark coordinate detection step (S44) are compared with the center coordinates of the grid mark 52 in the learning data D2, and the amount of distortion D4 of the base material 9 for each mark arrangement position is calculated (Step S45; a distortion amount calculation step).

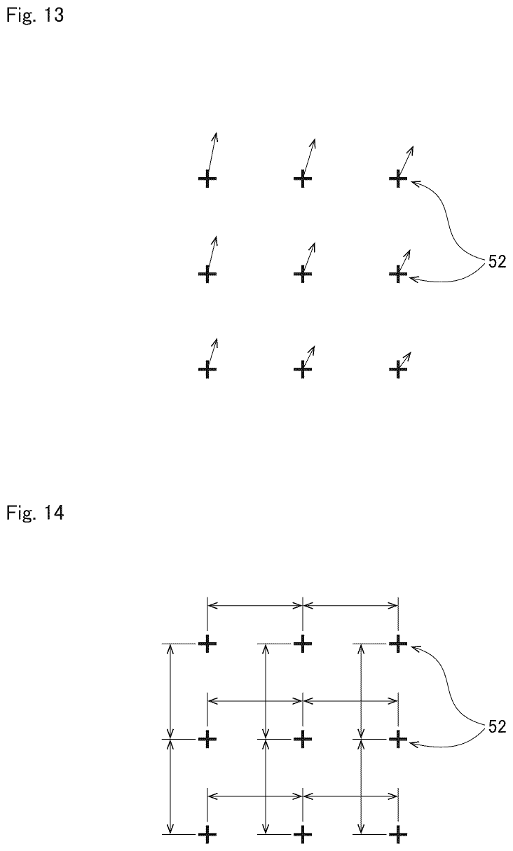

FIG. 13 is a view showing an example of a method of calculating the amount of distortion D4 of the base material 9. In the example of FIG. 13, the distortion amount measurement part 42 measures a position of the grid mark 52 in the region to be detected in the photographic image D3. Specifically, the distortion amount measurement part 42 uses a specific grid mark 52 in the photographic image D3 as an origin, to measure a coordinate position of each of the remaining grid marks 52 with respect to the origin. Then, a difference between the measured coordinate position and the coordinate position (mark arrangement position) of the grid mark 52 in the learning data D2 is calculated as an amount of distortion. That is, in the method of FIG. 13, an amount of displacement of each grid mark 52 on the base material 9 is measured. The distortion amount measurement part 42 performs such a measurement of the amount of distortion for all of the grid marks 52 in the photographic image D3. As a result, a vector map showing a distribution of the amounts of distortion on the base material 9 is provided.

The vector map provided by the measurement method of FIG. 13 represents the amount of displacement of the coordinate position of each portion of the base material 9. In this case, the estimation result outputted from the estimation model M to be described later also represents the amount of displacement of the coordinate position of each portion of the base material 9. Thus, the use of the measurement method of FIG. 13 makes it easy to use the estimation result during the correction of the coordinate positions of the inks for ejection onto the base material 9 in the correction value calculation part 45.

FIG. 14 is a view showing an example of a method of measuring the amount of distortion D4 of the base material 9. In the example of FIG. 14, the distortion amount measurement part 42 measures an interval between the grid marks 52 in the adjacent region to be detected in the photographic image D3. Then, the distortion amount measurement part 42 calculates a difference between the measured distance between the grid marks 52 and a distance between the grid marks 52 in the learning data D2, as the amount of distortion. That is, in the method of FIG. 14, a change in the interval between the adjacent grid marks 52 is measured. The distortion amount measurement part 42 performs such a measurement of the amount of distortion for all of the adjacent grid marks 52 in the photographic image D3. As a result, a heat map showing a distribution of the amounts of distortion on the base material 9 is provided.

When the base material 9 expands and contracts, an amount of displacement of each region on the base material 9 affects not only an amount of expansion/contraction of the region but also an amount of expansion/contraction of other regions. Therefore, the amount of distortion of the base material 9 is a value obtained by accumulating the amount of expansion/contraction of these. However, the heat map provided by the measurement method of FIG. 14 represents a local amount of distortion for each region of the base material 9. Thus, this heat map is easy to handle as teacher data in Step S5 to be described below.

### <5. Printing Process>

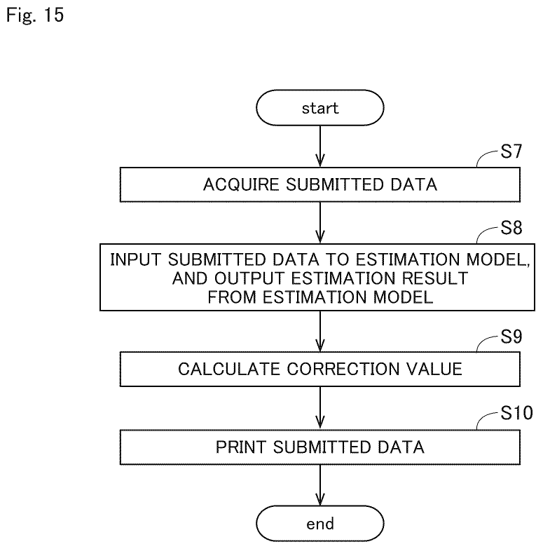

Next, a printing process executed in the printing apparatus 1 after the above-described learning process will be described. FIG. 15 is a flow diagram showing a procedure for the printing process.

For the printing process, the submitted data DI to be printed is initially acquired (Step S7; a data acquisition step), as shown in FIG. 15. Specifically, the data acquisition part 41 reads the submitted data D1 from the server 2. Then, the data acquisition part 41 inputs the submitted data D1 to the estimation part 44 and the operation control part 46.

The estimation part 44 inputs the submitted data D1 to the estimation model M generated by the learning part 43. Then, the estimation model M outputs the estimation result D5 of the amount of distortion of the base material 9 (Step S8; an estimation step). The estimation result D5 indicates an estimated value of the amount of distortion of the base material 9 resulting from inks when the submitted data D1 is printed in the printing apparatus 1. The estimation part 44 outputs the obtained estimation result D5 to the correction value calculation part 45.

The correction value calculation part 45 calculates the correction value D6, based on the estimation result D5 outputted from the estimation part 44 (Step S9). This correction value D6 is a control value for fine adjustment of the ejection position of ink droplets onto the base material 9. The correction value calculation part 45 sets the correction value D6 in a direction for canceling the distortion of the base material 9 indicated by the estimation result D5. For example, if a portion of the base material 9 is estimated to be displaced toward one side in the width direction thereof due to the expansion and contraction of the base material 9, the correction value calculation part 45 calculates the correction value D6 so that the ejection position of ink droplets is corrected toward the other side in the width direction. Then, the correction value calculation part 45 inputs the calculated correction value D6 to the operation control part 46.

Thereafter, the operation control part 46 controls the operations of the transport mechanism 10 and the four heads 21 to 24, based on the submitted data DI acquired from the data acquisition part 41 and the correction value D6 acquired from the correction value calculation part 45. The operation control part 46 corrects the ink ejection position specified by the submitted data D1 in accordance with the correction value D6. This correction is made, for example, for each pixel of the submitted data D1. Then, ink droplets are ejected at the corrected ejection position on the printing surface of the base material 9. Thus, the submitted data D1 is printed on the printing surface of the base material 9 (Step S10; a printing step).

As described above, the printing apparatus 1 estimates an amount of distortion of the base material 9 resulting from inks, based on the submitted data D1, prior to the printing of the submitted data D1. Thus, the printing apparatus 1 is capable of ejecting ink droplets onto the printing surface of the base material 9 while correcting the ink ejection position in consideration of the estimation result. As a result, the printing apparatus 1 provides high-quality printed products with less distortion of the printed image and with less misregistration.

### <6. Modifications>

While the one preferred embodiment according to the present invention has been described hereinabove, the present invention is not limited to the aforementioned preferred embodiment.

### <6-1. First Modification>

In the aforementioned preferred embodiment, the grid marks 52 are arranged in equally spaced apart relation in the learning data D2. However, the grid marks 52 need not necessarily be equally spaced apart from each other. For example, the grid marks 52 may be arranged more densely in a portion of the image 51 where a change in density value or in coverage rate is larger than in other portions thereof.

### <6-2. Second Modification>

In the aforementioned preferred embodiment, each of the grid marks 52 is comprised of the white base FIG. 521 and the black mark FIG. 522. However, the color of the base FIG. 521 is not necessarily limited to white. Also, the color of the mark FIG. 522 is not necessarily limited to black. For example, the base FIG. 521 may be black and the mark FIG. 522 may be white. The base FIG. 521 and the mark FIG. 522 may also be of other colors. It is only necessary that each of the grid marks 52 is comprised of the base FIG. 521 of a first color and the mark FIG. 522 of a second color different from the first color. In addition, the shapes of the base FIG. 521 and the mark FIG. 522 may be different from those of the aforementioned preferred embodiment.

### <6-3. Third Modification>

In the aforementioned preferred embodiment, the only information inputted to the estimation model M in the learning process is the learning data D2. However, additional information such as detected values from various sensors in the printing apparatus 1 and the type of the base material 9 in addition to the learning data D2 may be inputted to the estimation model M. In that case, the aforementioned additional information in addition to the submitted data D1 may be inputted to the estimation model M in the printing process. This allows the estimation model M to output the estimation result D5 with higher accuracy in consideration of the additional information.

### <6-4. Other Modifications>

In the aforementioned preferred embodiment, as shown in FIG. 2, the nozzles 201 are arranged in a line in the width direction in each of the heads 21 to 24. However, the nozzles 201 may be arranged in two or more lines in each of the heads 21 to 24 as shown in FIG. 2.

The printing apparatus 1 of the aforementioned preferred embodiment includes the four heads 21 to 24. However, the number of heads in the printing apparatus 1 may be in the range of one to three or not less than five. For example, the printing apparatus 1 may include a head for ejecting ink of a spot color in addition to those for K, C, M and Y.

The components described in the aforementioned preferred embodiment and in the modifications may be consistently combined together, as appropriate.

### REFERENCE SIGNS LIST

1 Printing apparatus
2 Server
9 Base material
10 Transport mechanism
20 Printing part
30 Camera
40 Computer
41 Data acquisition part
42 Distortion amount measurement part
43 Learning part
44 Estimation part
45 Correction value calculation part
46 Operation control part
51 Image
52 Grid mark
404 Computer program
D1 Submitted data
D2 Learning data
D3 Photographic image
D4 Amount of distortion
D5 Estimation result
D6 Correction value
M Estimation model
P, P1, P2, P3 Mark arrangement position
Q, Q21, Q22, Q3 First candidate region
R, R11, R12, R13, R14, R31, R32, R33 Second candidate region

1. A mark detection method for detecting a position of a position detection mark on a base material on which a learning image is printed in which the position detection mark is arranged at each of a plurality of mark arrangement positions,
the mark detection method comprising:
a) detecting, as a region to be detected, a region that meets a first condition that is predetermined, in a photographic image of the base material on which the learning image is printed;
b) determining a detection abnormality by comparing each of the mark arrangement positions with the region to be detected; and
c) detecting, as the region to be detected that is new, a region that meets a second condition that is predetermined, around each of the mark arrangement positions determined as the detection abnormality.

2. The mark detection method according to claim 1, wherein
in the operation b), the detection abnormality includes at least
a case where the region to be detected corresponding to a mark arrangement position among the mark arrangement positions is not detected; and
a case where a distance between a mark arrangement position among the mark arrangement positions and the region to be detected corresponding to the mark arrangement position is a predetermined outlier threshold value or more.

3. The mark detection method according to claim 1, wherein
the first condition is a region closest to each of the mark arrangement positions among first candidate regions whose degree of matching with the position detection mark is larger than a first matching degree threshold value that is predetermined,
the second condition is a region closest to each of the mark arrangement positions determined as the detection abnormality among second candidate regions whose degree of matching with the position detection mark is larger than a second matching degree threshold value that is predetermined, and
the second matching degree threshold value has a degree of matching lower than a degree of matching of the first matching degree threshold value.

4. The mark detection method according to claim 1, wherein
the position detection mark includes:
a base figure formed in a first color; and
a mark figure formed in a second color different from the first color at a position overlaid on the base figure.

5. The mark detection method according to claim 4, wherein
the first color is white, and
the second color is black.

6. A distortion amount measurement method for measuring an amount of distortion of an image printed on a base material,
the distortion amount measurement method comprising:
p) printing, on the base material, a learning image in which a position detection mark is arranged at each of a plurality of mark arrangement positions;
g) photographing the base material on which the learning image is printed, to acquire a photographic image;
r) detecting the region to be detected in the photographic image by the mark detection method according to claim 1; and
s) calculating an amount of distortion of the base material for each of the mark arrangement positions by comparing each of the mark arrangement positions with the region to be detected.

7. The distortion amount measurement method according to claim 6, wherein
the amount of distortion indicates an amount of displacement of each of a plurality of the position detection marks from each of the mark arrangement positions to the region to be detected.

8. The distortion amount measurement method according to claim 6, wherein
the amount of distortion indicates a change in an interval between adjacent mark arrangement positions among the mark arrangement positions and an interval between the regions to be detected that are corresponding to the adjacent mark arrangement positions.

9. A learning method for machine learning an estimation model for estimating an amount of distortion of a base material having an elongated strip shape, in a printing apparatus that ejects ink onto a surface of the base material while transporting the base material in a longitudinal direction,
the learning method comprising:
x) measuring an amount of distortion of the base material by the distortion amount measurement method according to claim 6, in a learning image in which a position detection mark is arranged at each of a plurality of mark arrangement positions; and
y) generating an estimation model capable of outputting an estimation result obtained by estimating an amount of distortion of the base material, by machine learning using the learning image as an input variable and using the amount of distortion measured in the operation x).

10. The learning method according to claim 9, wherein
the learning image is image data including a plurality of regions having different density values or different coverage rates.

11. An estimation method for estimating an amount of distortion of a base material having an elongated strip shape, in a printing apparatus that ejects ink onto a surface of the base material while transporting the base material in a longitudinal direction,
the estimation method comprising:
A) acquiring submitted data that is image data to be printed; and
B) inputting the submitted data to the estimation model learned by the learning method according to claim 9, and acquiring the estimation result output from the estimation model, prior to printing the submitted data.

12. A printing method using the estimation method according to claim 11, the printing method comprising
C) ejecting ink onto a surface of the base material while correcting an ejection position of ink with respect to the base material based on the estimation result,
after executing the operation A) and the operation B).
